(19) United States
(12) Patent Application Publication
(10) Pub. No.: US 2004/0034728 A1
(43) Pub. Date: Feb. 19, 2004

(54) Electronic card with high bandwidth and extended functions

(75) Inventors: Jung Ta Chang, Hsinchu (TW); Ping-Chang Liu, Hsinchu (TW); Chien-Chih Tseng, Taichung (TW); Edison Chang, Taichung (TW)

Correspondence Address: BACON & THOMAS, PLLC, 625 SLATERS LANE, FOURTH FLOOR, ALEXANDRIA, VA, 22314

(73) Assignees: C-One Technology Corporation, Hsin-Chu City (TW); Pretec Electronics Corporation, Fremont, CA

(21) Appl. No.: 10/347,794

(22) Filed: Jan. 22, 2003

(30) Foreign Application Priority Data
Aug. 14, 2002 (TW) 91212620

(51) Int. Cl. G06F 13/00

(52) U.S. Cl. 710/301

(57) ABSTRACT

There is provided an electronic card with extending pins for being inserted into a host. The electronic card has a plurality of front pins for providing standard power supply, data, address and control connections. The electronic further provides and a plurality of extending pins alternatively arranged with the plurality of front pins for providing a plurality of extending functions, wherein at least one extending pin is an identifying pin for enabling the host to identify whether the electronic card has extending pins.

### BACKGROUND OF THE INVENTION

1. Field of the Invention

The present invention relates to small cards, and particularly to a high bandwidth and extending functional small card.

2. Description of the Related Art

With the improvement of wireless network, the portable devices are more and more popular, such as PDAs, notebook computers, palm top computers, etc. Since the portable device can be easily carried everywhere and has the function of data processing, it provides a great convenience to the user. However, such a portable device is so compact that only basic processing circuit is arranged. Other circuit module is realized by add-on electronic cards, such as SD memory cards for storing data, and I/O cards, such as GPS cards, PC cards, blue tooth cards, etc.

Since the functions of electronic cards are more and more complex, the pins required in the electronic cards are increased rapidly. However, the current electronic card has insufficient pins. This will make the transmission bandwidth to be confined and real time control to be impossible. Thereby, the control about the slot and the electronic card becomes more and more difficult.

### SUMMARY OF THE INVENTION

Accordingly, the primary object of the present invention is to provide an electronic card with high bandwidth and extended functions, so as to increase the bandwidth and support a variety of transmission protocols.

Another object of the present invention is to provide an electronic card with high bandwidth and extended functions, which is compatible with electric properties and applications of current electronic cards.

To achieve above object, the present invention provides an electronic card with extending pins for being inserted into a host. The electronic card comprises: a plurality of front pins for providing standard power supply, data, address and control connections; and a plurality of extending pins alternatively arranged with the plurality of front pins for providing a plurality of extending functions, wherein at least one extending pin is an identifying pin for enabling the host to identify whether the electronic card has extending pins.

Moreover, the electronic card is suitable in one of serial periphery mode, SPI mode, UART mode and USB mode. The electronic card also can set an extended external application module via the extending pins, i.e., UART module and USB module. The electronic card that is set with a transmission mode communications with a host via the interface of the host, for example, SD or SDIO interface, extending SD I/O interface, Memory Stick or Memory Stick I/O interface, extending MSIO interface.

The various objects and advantages of the present invention will be more readily understood from the following detailed description when read in conjunction with the appended drawing.

### BRIEF DESCRIPTION OF THE DRAWINGS

FIG. 1 shows the perspective view of the present invention.

FIG. 2 is a schematic view showing the operation of the electronic card of the present invention with a host.

FIG. 3 shows the use of the extending pins in accordance with the first embodiment of the present invention.

FIG. 4 shows the use of the extending pins in accordance wit the second embodiment of the present invention.

FIG. 5 shows the use of the extending pins in accordance wit the third embodiment in the present invention.

FIG. 6 shows the settings of the power-on mode of the extending pins in the present invention.

### DETAILED DESCRIPTION OF THE PREFERRED EMBODIMENTS

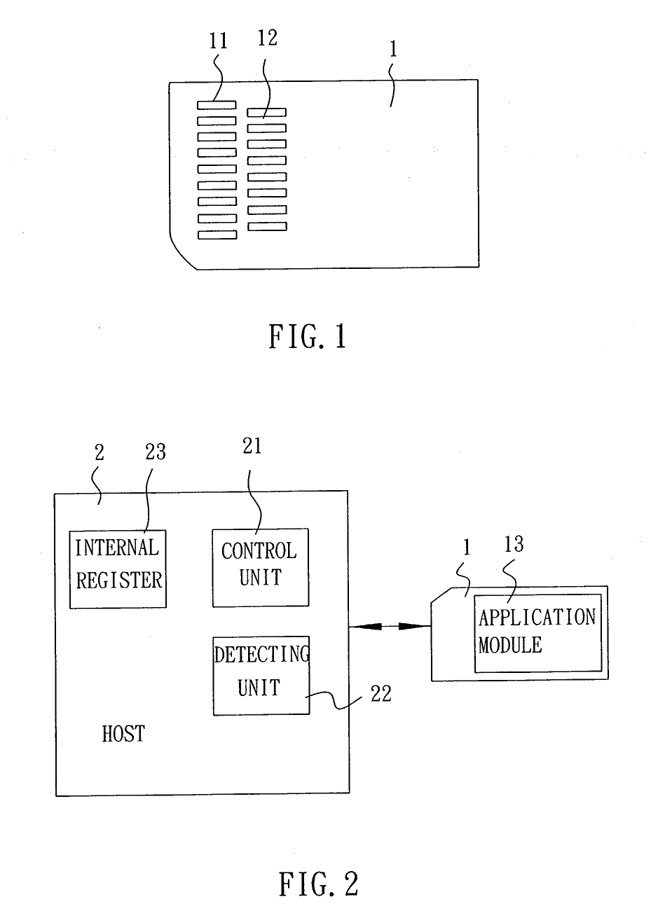

Referring to FIG. 1, the electronic card with high bandwidth and extended functions of the present invention is illustrated. The pins of the electronic card 1 comprise a plurality of front pins 11 and a plurality of extending pins 12. The front pins 11 and the extending pins 12 are arranged alternatively. The front pins 11 are placed at a front end of the electronic card 1 and the extending pins 12 are placed behind the front pins 11 or between the front end and the middle section of the electronic card 1.

The front pins 11 are original pins of a standard electronic card 1. Namely, the front pins 11 are used for providing power, data, addresses, and control connections in the transmission mode of an electronic card 1. The extending pins 12 serve for extending the input/output (I/O) functions or other extra data connections. For a standard SD cards, there are nine front pins 11 and preferably, there are six extending pins 12.

Referring to FIG. 2, the schematic view showing the connection of the electronic card 1 and the host 2 is illustrated. When the electronic card 1 is inserted into the host 2, and if the host 2 dose not support the extended function, the host 2 will not detect the extending pins 12 (referring to FIG. 1). Thereby, the electronic card 1 is operated by an original way (that is, the electronic card 1 is considered as a card without any extending pin, and only the front pins will be used).

If the host 2 supports the extended function of the electronic card 1, the detecting unit 22 in the host 2 will assure the electronic card 1 to be an electronic card 1 having extending pins via at least one extending pin. Then, the operation mode of the control unit 21 in the host 2 is changed so that the extending pins 12 can increase the bandwidth and extend the I/O function. After the operation mode is assured, the host 2 can set the electronic card 1 via an internal register 23 and two extending pins 12. The setting mode includes general-purpose I/O mode (GPIO), mixed mode, unused mode, cyclic redundancy check mode (CRC), etc.

The mixed mode is the mixing of GPIO and unused modes. The GPIO may be programmed in the general purpose output (GPO) mode. In the rule, the two extending pins 12 are used as two extending address lines to increase the addressable physical memory pages. The CRC mode is used to provide real time data check with 8-bit data bus so as to reduce the extra CRC cycles after the transmission package.

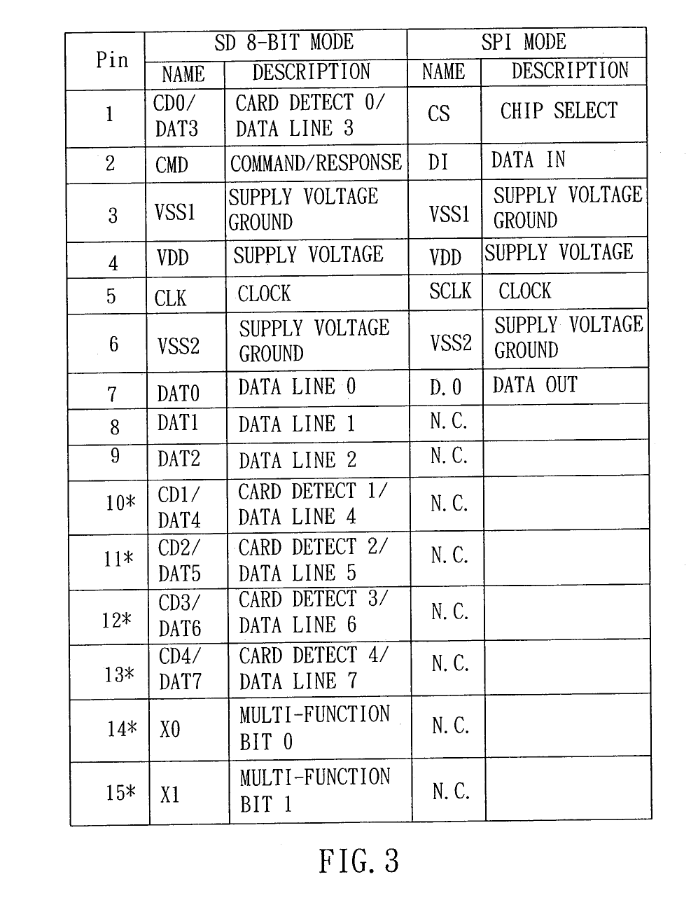

FIG. 3 shows the use of the extending pins in the first embodiment of the present invention. In this embodiment, the electronic card 1 is an SD memory card (referring to FIG. 2). The SD mode or SPI mode is used as the interface for communicating with the host 2. In this embodiment, the SD mode is used as an example.

The pin 1 to pin 9 are original defined pins of SD mode/SPI mode. The pin 10 to pin 15 are extending pins 12. The pin 10 to pin 13 (CD1 to CD4) are used as extending data transmission pins other than being used as card detecting pins. A pull-up resistor of 50 KΩ is built in the pin 13 (CD4), which will be removed after normal operation. Namely, after the electronic card 1 is inserted into the host 2, the detecting unit 22 will detect the pin 13 to be in “high”. In the normal operation condition, the pull-up resistor is removed. That is, after the electronic card 1 is inserted into the host 2, the detecting unit 22 detects that the values of CD1 to CD4 are [0001]. After normal operation, the CD1 to CD4 (pin 10 to pin 13) become data lines for extending the electronic card 1 to have a data bandwidth of 8 bits.

The pin 14 and pin 15 are functional set pins. By the pin 14 and pin 15, the electronic card 1 is set as a GPIO mode, mixed mode, unused mode, or CRC mode. Besides, the unused mode can be changed as an interrupted mode. Thereby, the electronic card 1 is set to have the interrupted mode and a data bandwidth of 8 bits.

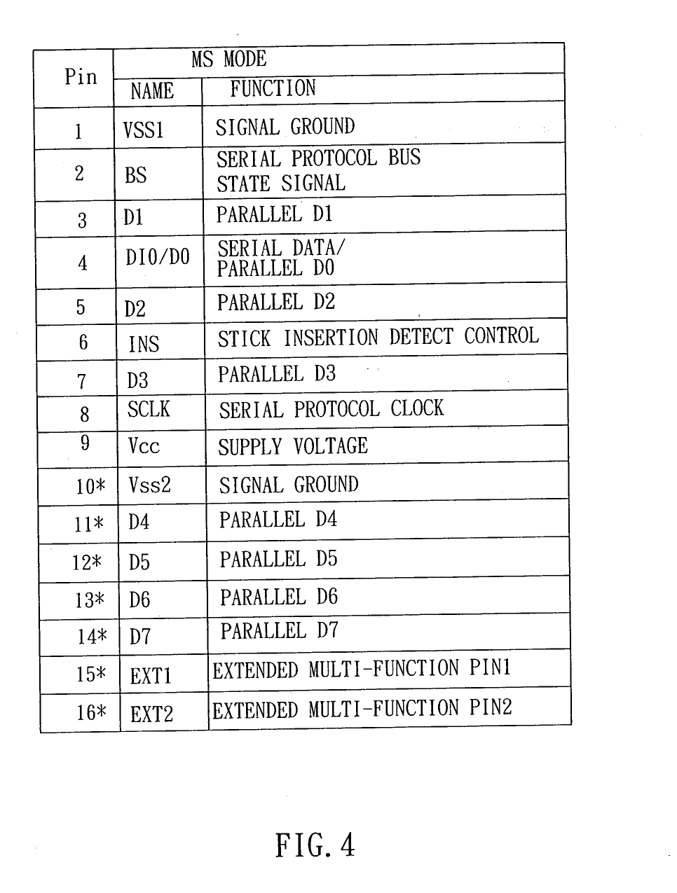

FIG. 4 shows the use of the extending pins in the second embodiment of the present invention. The electronic card 1 is a memory stick (MS) with extending pins or an MS I/O card. In this embodiment, the use of the extending pins is similar to the extending pins 12 of SD card. For example, a general MS card or I/O card defines 10 pins, and the electronic card 1 of this embodiment has 16 pins. Thus, the 10 pins of the 16 pins are used as the original pins of MS card or MS I/O card for powering, data transmission, addressing and controlling.

The other six pins are used as extending pins 12. Four of the pins serve for extending I/O capability or data transmission. Thereby, the MS card or MS I/O card has data bandwidth of 8 bits. At least one the extending pins 12 in the four extending pins 12 is used as an identification pin for identifying, so that the host 2 can determine whether the electronic card 1 has extending pins 12. Two of the extending pins 12 are used to set the function modes of an electronic card 1.

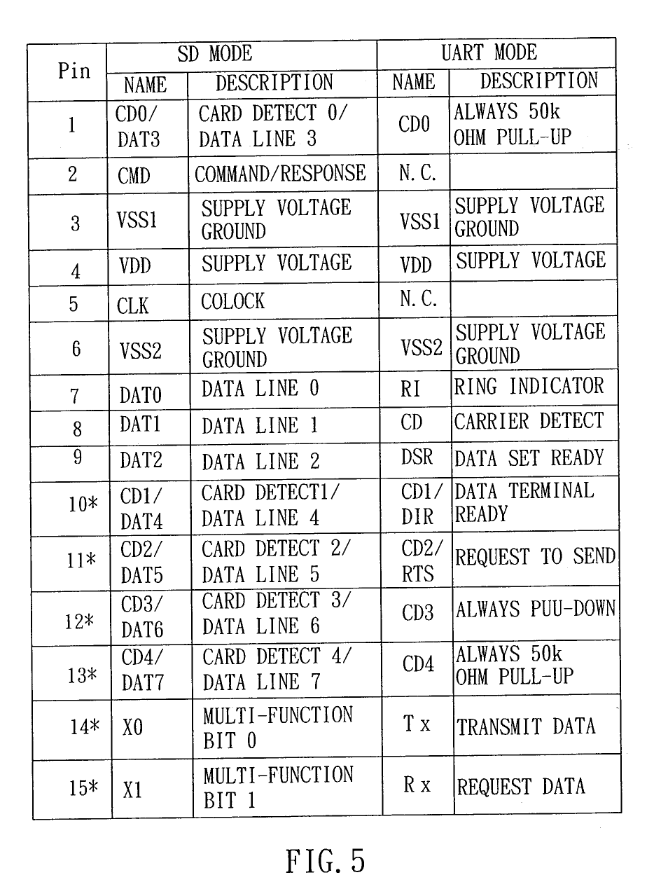

Fig.5 shows the use of the extending pins 12 in the third embodiment of the present invention. In this embodiment, the electronic card 1 supports an UART transmission mode and is suitable to be used in SD I/O and extended SD I/O mode. Namely, the electronic card 1 has an application module 13 suitable in the UART transmission mode. The host 2 is connected to the electronic card 1 via an SD interface (referring to FIG. 2). When the electronic card 1 is inserted into the host 2, the host 2 is communicable with the application module 13 of the UART transmission mode via the SD command interface. In this embodiment, the host 2 sets the transmission modes of the application module 13 via the pins 14 and 15 (Tx, Rx) so as to simplify the circuit design of the control unit 21 in the host 2 and to make the electronic card 1 compatible with more different hosts 2.

Moreover, in this embodiment, the use of the pins are similar to those in the first embodiment. Namely, the extending pins 12 and the front pins 11 are provided to extend the I/O of the electronic card 1 and increase the data bandwidth of 8 bits. Moreover, the function mode of the electronic card 1 is set through the pins 13 and 15, for example, to set the function mode of GPIO mode, CRC mode, etc. However, a pull-up resistor of 50 KΩ which is removed after normal operation is built in the pin 12 (CD3). That is, after the electronic card 1 is inserted into the host 2, the detecting unit 22 has an initial value [0010] after the host 2 is powered on.

Furthermore, the application module 13 in the electronic card 1 may be in a USB transmission mode or other transmission mode. When the application module 13 is in the USB transmission mode, other than the SD command interface, the host 2 can set the transmission mode of the application module 13 via the pins 14 and 15 (D+, D−). Then, the startup mode of the electronic card 1 can be changed by the pull-up resistor so that the initial value of the detecting unit 22 is [0011].

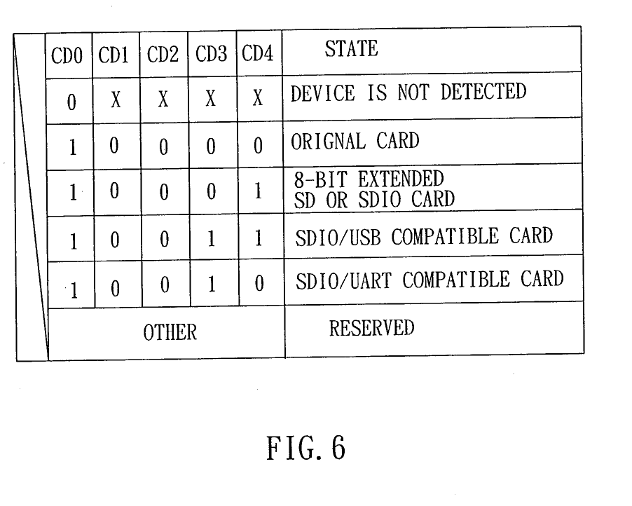

FIG. 6 shows the setting of the power-on mode of the extending pins. The pull-up resistor is positioned at the front pins 11 or the extending pins 12.

In view of the foregoing, it is known that the present invention utilizes a plurality of extending pins 12 to provide the I/O function and extend the data connection. Two pins in the extending pins 12 are used to set the function mode of the electronic card 1, for example, GPIO mode. In the host 2, two extending pins are used to set the transmission mode in the application module of the electronic card 1 so as to increase the transmission bandwidth and support various transmission protocols. Moreover, the electronic card 1 is compatible with other currently used electronic cards.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An electronic card with extending pins for being inserted into a host, comprising:
a plurality of front pins for providing standard power supply, data, address and control connections; and
a plurality of extending pins alternatively arranged with the plurality of front pins for providing a plurality of extending functions, wherein at least one extending pin is an identifying pin for enabling the host to identify whether the electronic card has extending pins.

2. The electronic card as claim in claim 1, wherein the plurality of extending functions comprises input/output function and extending data connection.

3. The electronic card as claim in claim 1, wherein after the electronic card is inserted into the host, at least one extending pin is pulled to “high” via a pull-up resistor, and then the pull-up resistor is removed.

4. The electronic card as claim in claim 1, wherein the plurality of front pins allow four bits data transmission; and the plurality of extending pins are extended data transmission pins which allow transmission bandwidth increase to 8-bit.

5. The electronic card as claim in claim 1, wherein the host has a register, and the host sets the functions of the electronic card via at least two extending pins and the register.

6. The electronic card as claim in claim 5, wherein the function mode set by the two extending pins includes general-purpose I/O mode (GPIO), mixed mode, unused mode and cyclic redundancy check (CRC) mode.

7. The electronic card as claim in claim 5, further comprising an application module, the host setting the application module via the two extending pins so that the host is communicable with the application module.

8. The electronic card as claim in claim 7, wherein the interface of the host includes one of an SD I/O mode, extended SD I/O mode, SD mode, serial peripheral interface mode, URAT mode and USB mode.

9. The electronic card as claim in claim 7, wherein the interface of the application module is one of a serial peripheral interface, an UART interface, and a USB interface.

10. The electronic card as claim in claim 1, wherein the electronic card is suitable in one of serial periphery mode, UART mode, USB mode, SD I/O mode, extended SD I/O mode, SD mode, extended SD mode, MS mode, extended MS mode; and extended MS I/O mode.

11. The electronic card as claim in claim 10, wherein when the electronic card is used in one of the SPI mode, USRT mode, USB mode, SD I/O mode, extended SD I/O mode, SD mode, and the extended SD mode, there are nine front pins and six extending pins.

12. The electronic card as claim in claim 10, wherein when the small card is used in MS mode, extended MS mode, or extended MS I/O mode, there are 10 front pins and six extending pins.

13. The electronic card as claim in claim 10, wherein there are six extending pins.
